(19) United States
(12) Patent Application Publication
(10) Pub. No.: US 2024/0163965 A1
(43) Pub. Date: May 16, 2024

(54) METHOD FOR ADJUSTING DURATION OF DRX CYCLE, TERMINAL DEVICE AND ACCESS NETWORK DEVICE

(71) Applicant: GUANGDONG OPPO MOBILE TELECOMMUNICATIONS CORP., LTD., Dongguan (CN)

(72) Inventors: Xue LIN, Dongguan (CN); Shukun WANG, Dongguan (CN)

(73) Assignee: GUANGDONG OPPO MOBILE TELECOMMUNICATIONS CORP., LTD., Dongguan (CN)

(21) Appl. No.: 18/422,971

(22) Filed: Jan. 25, 2024

Related U.S. Application Data
(63) Continuation of application No. PCT/CN2021/124198, filed on Oct. 15, 2021.

(51) Int. Cl. H04W 76/28; H04W 76/40

(52) U.S. Cl. CPC H04W 76/28; H04W 76/40

(57) ABSTRACT

A method for adjusting duration of a Discontinuous Reception (DRX) cycle, a terminal device and an access network device are provided. The method includes that: a terminal device receives Media Access Control (MAC) layer control information from an access network device; the terminal device determines a terminal service to which the MAC layer control information is applicable, the terminal service includes a multicast service or a unicast service; and the terminal device adjusts the duration of the DRX cycle for receiving the terminal service.

### CROSS-REFERENCE TO RELATED APPLICATION

This is a continuation of International Patent Application No. PCT/CN2021/124198, filed on Oct. 15, 2021, the disclosure of which is hereby incorporated by reference in its entirety.

### BACKGROUND

Multimedia Broadcast Multicast Service (MBMS) is a technology that transmits data from one data source to multiple user equipment by sharing network resources. The network resources may be effectively utilized by the MBMS to realize a multimedia broadcast service and a multimedia multicast service at a high rate. With an evolution of a communication network, the multicast service and the broadcast service are gradually introduced into New Radio (NR), for example, the multicast service needs to be introduced to support the access of multiple terminals in Internet of Vehicles, Industrial Internet and other services.

A terminal device may be configured with a DRX cycle, such that the terminal device may sleep or monitor a Physical Downlink Control Channel (PDCCH) in the DRX cycle to save power consumption. An access network device instructs the terminal device to switch duration of the DRX cycle through Media Access Control Control Element (MAC CE).

### SUMMARY

The disclosure relates to the field of communication technologies, and more particularly to a method for adjusting duration of a Discontinuous Reception (DRX) cycle, a terminal device and an access network device.

In a first aspect, a method for adjusting duration of a DRX cycle is provided, which includes the following operations.

A terminal device receives Media Access Control (MAC) layer control information from an access network device.

The terminal device determines a terminal service to which the MAC layer control information is applicable. The terminal service includes a multicast service or a unicast service.

The terminal device adjusts the duration of the DRX cycle for receiving the terminal service.

In a second aspect, a terminal device is provided, which includes a processor, a memory and a transceiver. The processor, the memory and the transceiver communicate with each other via an internal connection path. The memory is configured to store program codes.

The processor is configured to call the program codes stored in the memory to: control the transceiver to receive MAC layer control information from an access network device; determine a terminal service to which the MAC layer control information is applicable, the terminal service including a multicast service or a unicast service; and adjust duration of a DRX cycle for receiving the terminal service.

In a third aspect, an access network device is provided, which includes a processor, a memory and a transceiver. The processor, the memory and the transceiver communicate with each other via an internal connection path. The memory is configured to store program codes.

The processor is configured to call the program codes stored in the memory to: generate MAC layer control information; and control the transceiver to send the MAC layer control information to a terminal device. The MAC layer control information is used for adjusting duration of a DRX cycle for receiving a terminal service to which the MAC layer control information is applicable. The terminal service includes a multicast service or a unicast service.

### BRIEF DESCRIPTION OF THE DRAWINGS

The drawings described herein are used for providing further understanding of the disclosure, and constitute a part of the disclosure. Schematic embodiments of the disclosure and description thereof are used for illustrating the disclosure and not intended to form an improper limit to the disclosure. In the drawings:

FIG. 1 is a schematic diagram illustrating a DRX cycle according to an embodiment of the disclosure.

FIG. 2 is a framework diagram of a communication system according to an embodiment of the disclosure.

FIG. 3 is a flowchart illustrating a method for adjusting duration of a DRX cycle according to an embodiment of the disclosure.

FIG. 4 is a flowchart illustrating a method for adjusting duration of a DRX cycle according to another embodiment of the disclosure.

FIG. 5 to FIG. 10 are schematic diagrams illustrating message structures according to embodiments of the disclosure.

FIG. 11 is a flowchart illustrating a method for adjusting duration of a DRX cycle according to yet another embodiment of the disclosure.

FIG. 12 is a flowchart illustrating a method for adjusting duration of a DRX cycle according to still another embodiment of the disclosure.

FIG. 13 is a structural diagram of a terminal device according to an embodiment of the disclosure.

FIG. 14 is a structural diagram of an access network device according to an embodiment of the disclosure.

FIG. 15 and FIG. 16 are structural diagrams of computer devices according to embodiments of the disclosure.

FIG. 17 is a structural diagram of a chip according to an embodiment of the disclosure.

### DETAILED DESCRIPTION

In order to make objects, technical solutions and advantages of the disclosure clearer, the disclosure will be described below in detail with reference to the drawings and the embodiments of the disclosure. It should be understood that the specific embodiments described herein are used for illustrating the disclosure only and not intended to limit the disclosure.

Firstly, in order to facilitate the understanding of the technical solutions described in the disclosure, the terms involved in the embodiments of the disclosure are explained and illustrated.

(1) Unicast

Unicast may be a communication between a sender and a receiver. For example, the unicast may be a point-to-point communication between a terminal device and an access network device.

(2) Multicast

Unlike the unicast communication, multicast may be communications between a sender and multiple receivers. Multicast may include multicast and broadcast. For example, a base station may send system messages via broadcast or send downlink messages to User Equipment (UE) groups via multicast.

(3) DRX Cycle

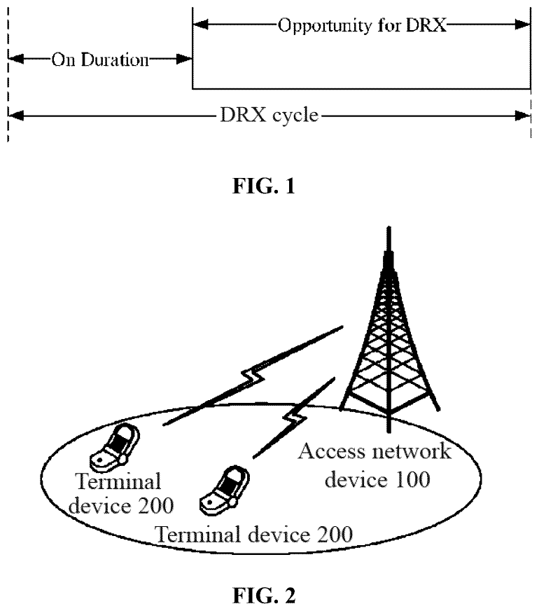

As illustrated in FIG. 1, the DRX cycle includes “On Duration” and “Opportunity for DRX”. In “On Duration”, UE is in a wake-up state and may monitor PDCCH. In “Opportunity for DRX”, UE enters a sleep state to save power, and does not monitor the PDCCH. It can be understood that the longer the duration of “Opportunity for DRX”, the lower the power consumption of UE.

The DRX cycle may be classified into a long DRX cycle and a short DRX cycle based on the duration of “Opportunity for DRX”. The duration of “Opportunity for DRX” in the long DRX cycle is longer than that of “Opportunity for DRX” in the short DRX cycle.

The methods described in the embodiments of the disclosure are applicable to the communication system illustrated in FIG. 2. FIG. 2 is a schematic diagram illustrating a communication system to which the technical solutions provided herein apply. The communication system may include one or more access network devices 100 (only one is illustrated in FIG. 2) and one or more terminal devices 200. FIG. 2 is only a schematic diagram, and does not constitute a limitation to the applicable scenarios of the technical solutions provided by the disclosure.

The access network device 100 may be a Transmission Reception Point (TRP), a base station, a relay station, an access point, and/or the like. The access network device 100 may be an access network device in a 5th Generation (5G) communication system or an access network device in a future evolution network. The access network device 100 may also be a wearable device or a vehicle-mounted device. In addition, the access network device 100 may further be a Base Transceiver Station (BTS) in a Global System for Mobile communication (GSM) or a Code Division Multiple Access (CDMA) network. The access network device 100 may further be a Node B (NB) in a Wideband Code Division Multiple Access (WCDMA) network. The access network device 100 may further be an evolutional NB (eNB) or an evolutional NodeB (eNodeB) in Long Term Evolution (LTE). The access network device 100 may further be a wireless controller in a Cloud Radio Access Network (CRAN) scenario.

The terminal device 200 may be UE, an access terminal, a UE unit, a UE station, a mobile radio station, a mobile station, a remote station, a remote terminal, a mobile device, a UE terminal, a wireless communication device, a UE agent or a UE apparatus. The access terminal may be a cellular telephone, a cordless telephone, a Session Initiation Protocol (SIP) telephone, a Wireless Local Loop (WLL) station, a Personal Digital Processor (PDA), a handheld device with a wireless communication function, a computing device or other processing devices connected to a wireless modem, a vehicle-mounted device, a wearable device, a terminal in a 5G network, a terminal in a future evolved Public Land Mobile Network (PLMN), and/or the like.

DRX-related MAC CE is defined in NR, which may be referred to as DRX command MAC CE, and the terminal device is instructed to switch duration of a DRX cycle through the MAC CE. Specifically, the MAC CE that instructs the switching of the duration of the DRX cycle includes DRX command MAC CE and long DRX MAC CE. After receiving the DRX command MAC CE from the access network device, the terminal device may switch from a long DRX cycle to a short DRX cycle. After receiving the long DRX MAC CE from the access network device, the terminal device switches from the short DRX cycle to the long DRX cycle.

After an introduction of a multicast service in NR, multicast and unicast are independent of each other. The terminal device may identify whether a long DRX cycle or a short DRX cycle is used for receiving a terminal service based on the DRX command MAC CE and the long DRX MAC CE. However, the terminal device cannot identify whether the DRX command MAC CE and the long DRX MAC CE are used for receiving a multicast service or a unicast service, and the multicast service and the unicast service cannot be configured separately in the switching of duration of the DRX cycle, which causes confusion in the behavior of the terminal device, and the duration of the DRX cycle cannot be switched correctly.

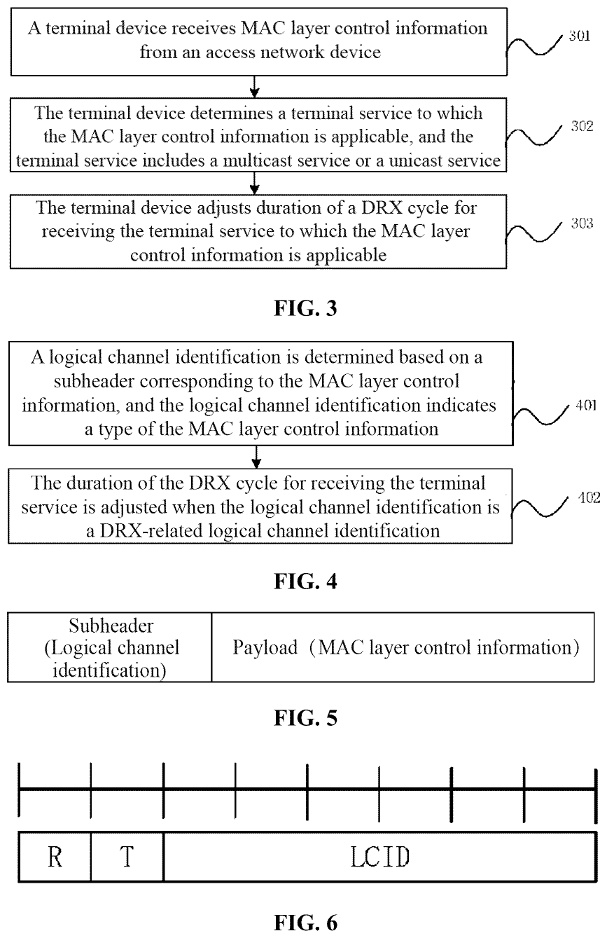

Based on this, an embodiment of the disclosure provides a method for adjusting duration of a DRX cycle, which can distinguish whether the MAC CE is used for receiving a multicast service or a unicast service. In this way, the DRX command MAC CE may be configured for the multicast service and the unicast service separately, to avoid confusion in the behavior of the terminal device and instruct the terminal device to switch the duration of the DRX cycle. As illustrated in FIG. 3, the method includes the following operations.

At operation 301, a terminal device receives MAC layer control information from an access network device.

The MAC layer control information may be DRX-related MAC layer control information, for example, may be the DRX command MAC CE or the long DRX command MAC CE.

In a specific implementation, the terminal device receives a MAC sub Protocol Data Unit (PDU), and the MAC sub PDU includes a subheader and a payload. The subheader contains a logical channel identification, the payload contains the MAC layer control information, and the logical channel identification in the subheader may indicate a type of the MAC layer control information in the payload. For example, the logical channel identification in the subheader may indicate whether the payload contains the DRX command MAC CE or the long DRX command MAC CE. The logical channel identification may be a logical channel identity document, or LCID for short. That is, the terminal device may acquire the MAC layer control information by receiving the MAC sub PDU.

In an example, when the logical channel identification in the subheader is “1”, it indicates that the payload of the MAC sub PDU contains the DRX command MAC CE. When the logical channel identification in the subheader is “0”, it indicates that the payload of the MAC sub PDU contains the long DRX command MAC CE.

At operation 302, the terminal device determines a terminal service to which the MAC layer control information is applicable. The terminal service includes a multicast service or a unicast service.

In the embodiment of the disclosure, the unicast service and the multicast service are configured separately. After receiving the MAC layer control information, the terminal device may determine whether the MAC layer control information is applicable to the multicast service or the unicast service, so as to switch the duration of the DRX cycle for receiving the corresponding service based on the MAC layer control information. The duration of the DRX cycle can be switched correctly by determining the terminal service to which the MAC layer control information is applicable, and an incorrect switching caused by confusion in the behavior of UE can be avoided.

The multicast service may include multicast and broadcast, and the unicast service may be a point-to-point communication service between the terminal device and the access network device.

In a specific implementation, the terminal device may determine whether the MAC layer control information is applicable to the multicast service or the unicast service based on content carried in the MAC layer control information; or may determine whether the MAC layer control information is applicable to the multicast service or the unicast service based on content carried in a subheader corresponding to the MAC layer control information; or may determine whether the MAC layer control information is applicable to the multicast service or the unicast service based on a receiving resource for the subheader. The subheader corresponding to the MAC layer control information is a subheader corresponding to the payload that carries the MAC layer control information.

In a possible implementation, the content carried in the MAC layer control information may be a specified field in the MAC layer control information, for example, a reserved field, a reuse of an existing field, etc. The content carried in the subheader may be a specified field in the subheader, for example, a reserved field, a reuse of an existing field, etc. The receiving resource for the subheader may be a Physical Downlink Shared Channel (PDSCH) that carries the subheader, or may be a scrambling identifier of the PDSCH. The scrambling identifier may be a Radio Network Temporary Identifier (RNTI).

At operation 303, the terminal device adjusts the duration of the DRX cycle for receiving the terminal service to which the MAC layer control information is applicable.

In a specific implementation, the terminal device may determine the DRX cycle indicated by the MAC layer control information. For example, the terminal device may determine whether the MAC layer control information indicates a long DRX cycle or a short DRX cycle. That is, it is determined whether the MAC CE (i.e., the MAC layer control information) received at operation 301 is the DRX command MAC CE or the long DRX command MAC CE.

In an example, the terminal device may determine that the MAC layer control information is the DRX-related MAC CE based on a logical channel identification in the subheader corresponding to the MAC layer control information, for example, whether the MAC layer control information is the DRX command MAC CE or the long DRX command MAC CE is determined based on the logical channel identification in the subheader.

In the method provided by the embodiment of the disclosure, after receiving the MAC layer control information from the access network device, the terminal device may determine whether the MAC layer control information is applicable to the multicast service or the unicast service, so that the duration of the DRX cycle may be switched differentially for the reception of the multicast service or the reception of the unicast service, and the multicast service and the unicast service may be configured separately, which may prevent the terminal device from blindly switching the duration of the DRX cycle, and ensure that the switching of the duration of the DRX cycle matches with the service type accurately.

In another embodiment of the disclosure, the terminal device may determine a type of the MAC layer control information based on the logical channel identification, so that the terminal device can adjust the duration of the DRX cycle correctly. Illustratively, with reference to FIG. 4, the detailed implementation of adjusting the duration of the DRX cycle for receiving the terminal service by the terminal device includes the following operations.

At operation 401, a logical channel identification is determined based on a subheader corresponding to the MAC layer control information. The logical channel identification indicates a type of the MAC layer control information.

In a specific implementation, the terminal device may parse the subheader corresponding to the MAC layer control information to obtain the logical channel identification, and determine the type of the MAC layer control information based on the logical channel identification. The type of the MAC layer control information includes: the DRX-related MAC CE, the DRX command MAC CE or the long DRX command MAC CE.

Illustratively, with reference to FIG. 5, the terminal device receives a MAC sub PDU which includes a subheader and a payload. The subheader includes the logical channel identification, and the payload includes the MAC layer control information. The terminal device may determine the type of the MAC layer control information based on the logical channel identification in the subheader.

At operation 402, the duration of the DRX cycle for receiving the terminal service is adjusted based on the MAC layer control information when the logical channel identification is the DRX-related logical channel identification.

In a specific implementation, when the terminal device identifies the logical channel identification as the DRX-related logical channel identification, the terminal device determines that the MAC layer control information is the DRX-related MAC CE, which instructs the terminal device to adjust the duration of the DRX cycle. Based on this, the terminal device may adjust the duration of the DRX cycle for receiving the terminal service to which the MAC layer control information is applicable based on the MAC layer control information.

In a possible implementation, the DRX cycle supported by the terminal device may be classified into a long DRX cycle and a short DRX cycle.

The operation of adjusting the duration of the DRX cycle for receiving the terminal service in the operation 402 includes: switching a DRX cycle corresponding to the terminal service to which the MAC layer control information is applicable to a DRX cycle indicated by the MAC layer control information.

For example, it is determined that the MAC layer control information indicates the long DRX cycle based on the LCID, and when the MAC layer control information is applicable to the multicast service, the DRX cycle corresponding to the multicast service is switched to the long DRX cycle, and the long DRX cycle is subsequently used to receive the multicast service. When the MAC layer control information is applicable to the unicast service, the DRX cycle corresponding to the unicast service is switched to the long DRX cycle, and the long DRX cycle is subsequently used to receive the unicast service.

When it is determined that the MAC layer control information indicates the short DRX cycle based on the LCID, and when the MAC layer control information is applicable to the multicast service, the DRX cycle corresponding to the multicast service is switched to the short DRX cycle, and the short DRX cycle is subsequently used to receive the multicast service. When the MAC layer control information is applicable to the unicast service, the DRX cycle corresponding to the unicast service is switched to the short DRX cycle, and the short DRX cycle is subsequently used to receive the unicast service.

In another embodiment of the disclosure, the logical channel identification may indicate not only the type of the MAC layer control information, but also a type of the terminal service. The terminal device may determine the terminal service to which the MAC layer control information is applicable based on the logical channel identification.

In a specific implementation, a logical channel identification corresponding to the unicast service is different from a logical channel identification corresponding to the multicast service. That is, in order to distinguish between the unicast service and the multicast service, different logical channel identifications are defined for the MAC layer control information corresponding to the unicast service and the MAC layer control information corresponding to the multicast service. The terminal device may identify whether the MAC layer control information in the payload is applicable to the unicast service or the multicast service based on the logical channel identification in the subheader.

For example, a logical channel identification A and a logical channel identification B are defined for the multicast service. The logical channel identification A indicates the DRX command MAC CE applicable to the multicast service and the logical channel identification B indicates the long DRX command MAC CE applicable to the multicast service.

The unicast service may follow the current DRX-related MAC CE, for example, the unicast service corresponds to a logical channel identification C and a logical channel identification D. The logical channel identification C indicates a DRX command MAC CE applicable to the unicast service, and the logical channel identification D indicates a long DRX command MAC CE applicable to the unicast service.

It should be noted that the MAC CE applicable to the multicast service may be referred to as MBS DRX command MAC CE or MBS Long DRX command MAC CE.

In a possible implementation, after determining the type of the service to which the MAC layer control information is applicable based on the logical channel identification, the terminal device may adjust the duration of the DRX cycle for receiving all services of the type based on the MAC layer control information.

For example, the network device may configure one or more multicast services for the terminal device, and when the MAC layer control information is applicable to the multicast service, the terminal device may adjust the duration of the DRX cycle for receiving all currently configured multicast services.

The network device may also configure one or more unicast services for the terminal device, and when the MAC layer control information is applicable to the unicast service, the terminal device may adjust the duration of the DRX cycle for receiving all currently configured unicast services.

In the method provided by the embodiment of the disclosure, the logical channel identification may indicate both the type of terminal service and the type of the MAC layer control information. The terminal device, after obtaining the logical channel identification, can not only identify the type of MAC layer control information, but also determine the type of terminal service to which the MAC layer control information is applicable. Therefore, the unicast service and the multicast service are configured separately with less field overhead, and a processing complexity of the terminal device is reduced.

In another embodiment of the disclosure, a subheader corresponding to the MAC layer control information carries a field indicating a terminal service, and the terminal device may determine whether the MAC layer control information is applicable to a multicast service or a unicast service based on the subheader. Illustratively, the terminal device may determine first information based on a subheader corresponding to the MAC layer control information. The first information indicates that the MAC layer control information is applicable to the unicast service or indicates that the MAC layer control information is applicable to the multicast service, so that the terminal device may determine the terminal service to which the MAC layer control information is applicable based on the first information.

Illustratively, the first information is contained in the subheader corresponding to the MAC layer control information, and the terminal device may acquire the first information from the subheader. Optionally, the first information is in the subheader.

In a possible implementation, the first information may be information filled in a specific field in the subheader corresponding to the MAC layer control information. Illustratively, with reference to FIG. 6, the subheader corresponding to the MAC layer control information includes 8 bits, and the first two bits are reserved bytes R. Embodiments of the disclosure may use the reserved bytes in the subheader to indicate the terminal service.

For example, a second reserved field in the subheader is filled with the first information T. When T=0, it indicates that the MAC layer control information is applicable to the unicast service. When T=1, it indicates that the MAC layer control information is applicable to the multicast service.

It should be noted that the field in which the first information is located is not limited in the embodiment of the disclosure, and the first information may occupy one bit in the subheader or multiple bits in the subheader.

In a possible implementation, after determining the type of the service to which the MAC layer control information is applicable based on the first information, the terminal device adjusts the duration of the DRX cycle for receiving all services of this type based on the MAC layer control information.

In the method provided by the embodiment of the disclosure, the type of the MAC layer control information is indicated by the logical channel identification, and the terminal service is indicated by the specific field in the subheader. The terminal device may identify the type of the MAC layer control information after acquiring the logical channel identification, and may further determine the type of the service to which the MAC layer control information is applicable based on the specific field in the subheader. In this way, the unicast service and the multicast service can be configured separately by using different fields, thereby preventing the terminal device from blindly adjusting the duration of the DRX cycle.

In another embodiment of the disclosure, a RNTI for scheduling the MAC layer control information may be used to indicate the terminal service. Illustratively, the terminal device may determine the RNTI for scheduling the MAC layer control information, and determine a terminal service to which the MAC layer control information is applicable based on the RNTI.

The RNTI for scheduling the MAC layer control information is used for scrambling PDSCH, the PDSCH is used for carrying a downlink message, and the downlink message includes a subheader and a payload. The payload contains the MAC layer control information.

In a possible implementation, the access network device may scramble scheduling information for the multicast service and scheduling information for the unicast service through different RNTIs. The RNTI for scrambling the scheduling information for the unicast service may be referred to as Cell Radio Network Temporary Identifier (C-RNTI), and the RNTI for scrambling the scheduling information for the multicast service may be referred to as Group Radio Network Temporary Identifier (G-RNTI).

In a specific implementation, after determining a RNTI for scheduling the MAC layer control information, the terminal device determines that the MAC layer control information is applicable to the multicast service when the RNTI is dedicated to the multicast service; and the terminal device determines that the MAC layer control information is applicable to the unicast service when the RNTI is dedicated to the unicast service.

In an example, the access network device may schedule a PDSCH by a PDCCH, scrambles the PDCCH with an RNTI, and the PDSCH carries a MAC sub PDU. The MAC sub PDU includes a subheader and MAC CE. When the MAC CE is applicable to the unicast service, C-RNTI is used to scramble the PDCCH. When the MAC CE is applicable to the multicast service, G-RNTI is used to scramble the PDCCH. The C-RNTI is an RNTI dedicated to scheduling the unicast service, and the G-RNTI is an RNTI dedicated to scheduling the multicast service.

In the method provided by the embodiment of the disclosure, the type of the MAC layer control information is indicated by the logical channel identification, and the terminal service is indicated by the RNTI for scheduling the MAC layer control information. The terminal device may identify the type of the MAC layer control information after acquiring the logical channel identification, and may further determine the type of the service to which the MAC layer control information is applicable based on the RNTI for scheduling the MAC layer control information. In this way, the unicast service and the multicast service can be configured separately by indicating the terminal service implicitly through the RNTI, thereby preventing the terminal device from blindly adjusting the duration of the DRX cycle and reducing a field overhead.

In another embodiment of the disclosure, the subheader may contain a field indicating a length of the MAC layer control information in the payload, and the terminal service may be indicated by including or not including the field in the subheader. Illustratively, whether the subheader corresponding to the MAC layer control information includes second information is determined, and the second information indicates a length of the MAC layer control information. The terminal service to which the MAC layer control information is applicable is determined based on the determination of whether the subheader corresponding to the MAC layer control information includes the second information.

When the subheader corresponding to the MAC layer control information includes the second information, it indicates that the length of the MAC layer control information is variable, and the multicast services to which the MAC layer control information is specifically applicable may be indicated in the MAC layer control information, thus, it may be determined that the MAC layer control information is applicable to the multicast service. When the subheader corresponding to the MAC layer control information does not include the second information, it indicates that the length of the MAC layer control information is not variable, and the MAC layer control information is applicable to the unicast service.

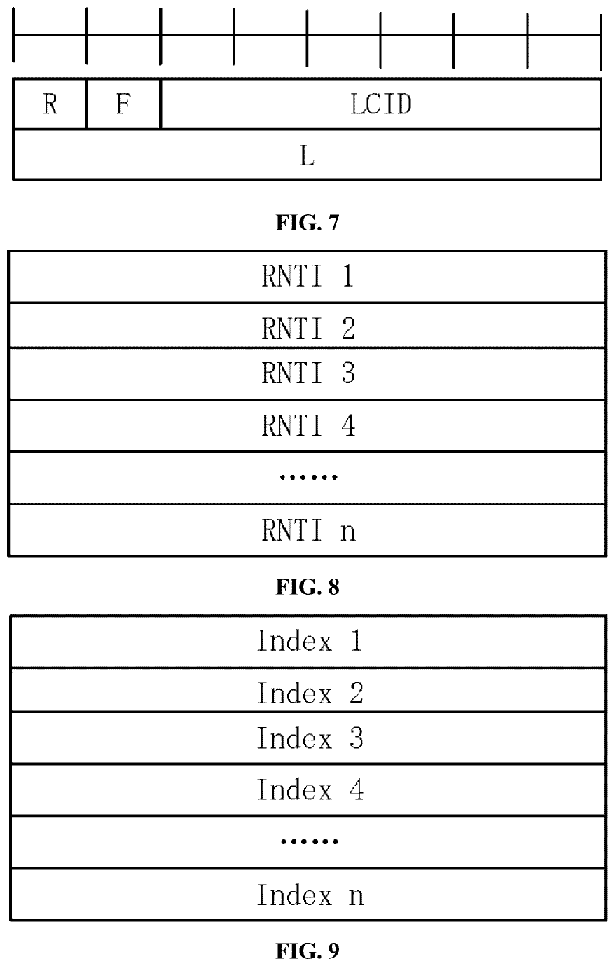

In an example, with reference to FIG. 7, the subheader includes a reserved field R, a field F, an LCID, and a field L. The reserved field R, the field F and the LCID occupy 8 bits, and the field L occupies 8 bits. The field F indicates whether the subheader carries the field L, and the field L is the second information described in the embodiment of the disclosure, which indicates the length of the MAC layer control information.

For example, if the field F is “1”, it indicates that the subheader carries the field L, and if the field F is “0”, it indicates that the subheader does not carry the field L. When the subheader includes the field L, the terminal device determines that the MAC layer control information corresponding to the subheader is applicable to the multicast service. When the subheader does not include the field L, the terminal device determines that the MAC layer control information corresponding to the subheader is applicable to the unicast service.

In a possible implementation, the terminal device may determine whether the field L is included in the subheader based on the field F, that is, whether the second information is included in the subheader is determined by the field F in the subheader.

In the method provided by the embodiment of the disclosure, the type of MAC layer control information is indicated by the logical channel identification, and the terminal service is indicated by the way of “including or not including the field indicating the length of MAC CE in the subheader”. The terminal device may identify the type of the MAC layer control information after acquiring the logical channel identification, and may further determine the type of service to which the MAC layer control information is applicable based on the determination of “whether the subheader contains the field indicating the length of MAC CE”. The unicast service and the multicast service can be configured separately by indicating the terminal service implicitly in this way, thereby preventing the terminal device from blindly adjusting the duration of the DRX cycle and reducing a field overhead.

In another embodiment of the disclosure, when the subheader contains the field indicating the length of the MAC CE, it indicates that the length of the MAC layer control information is variable, and the MAC layer control information may indicate the multicast service to which the MAC layer control information is specifically applicable. For example, when the subheader corresponding to the MAC layer control information includes the second information, the MAC layer control information includes third information indicating an adjustment of duration of a DRX cycle for receiving one or more multicast services.

The terminal device determines whether the MAC layer control information is applicable to the multicast service based on the determination of “whether the subheader contains the second information”, and may further determine the multicast services to which the MAC layer control information is specifically applicable based on the third information in the MAC layer control information. For example, the one or more multicast services indicated by the third information are determined as the terminal services to which the MAC layer control information is applicable.

In the embodiment of the disclosure, an implementation of the third information includes the following three ways.

In a first implementation, the third information includes an RNTI, and the multicast service to which the MAC layer control information is applicable is indicated by the RNTI.

In a specific implementation, the third information includes one or more RNTIs. The terminal device may determine one or more multicast services based on the one or more RNTIs in the third information, and further determine the one or more multicast services as the terminal services to which the MAC layer control information is applicable.

Each of the one or more RNTIs corresponds to a respective one of the one or more multicast services, and the RNTI may be a G-RNTI dedicated to scheduling the multicast service at the network side. The correspondence between the RNTIs and the multicast services may be pre-configured by the network side.

In an example, the third information includes an RNTI list illustrated in FIG. 8. The RNTI list includes N RNTIs, which are RNTI 1 to RNTI n, respectively. RNTI 1 indicates a multicast service 1, RNTI 2 indicates a multicast service 2 . . . and RNTI n indicates a multicast service n. The terminal device may determine n multicast services to which the MAC layer control information is applicable based on the RNTI list in the MAC layer control information, and the terminal device may adjust the duration of the DRX cycle for receiving the n multicast services based on the MAC layer control information.

In a second implementation, the third information includes an index. The multicast service to which the MAC layer control information is applicable is indicated by the index.

In a specific implementation, the third information includes one or more indexes, which may be indexes of RNTIs. The terminal device may determine one or more multicast services based on the one or more indexes in the third information, and determine the one or more multicast services as the terminal services to which the MAC layer control information is applicable.

Each of the one or more indexes corresponds to a respective one of the one or more multicast services. The correspondence between the indexes and the multicast services may be pre-configured by the network side.

In a possible implementation, there is a correspondence between the RNTIs and the multicast services. The terminal device may determine one or more RNTIs associated with the one or more indexes, and further determine the multicast services to which the MAC layer control information is applicable based on the correspondence between the RNTIs and the multicast services.

In an example, the third information includes an index list illustrated in FIG. 9. The index list includes N indexes, which are index 1 to index n, respectively. Index 1 indicates a multicast service 1, index 2 indicates a multicast service 2 . . . and index n indicates a multicast service n. The terminal device may determine n multicast services to which the MAC layer control information is applicable based on the index list in the MAC layer control information, and the terminal device may adjust the duration of the DRX cycle for receiving the n multicast services based on the MAC layer control information.

In a third implementation, the third information includes a bitmap. The multicast services to which the MAC layer control information is applicable are indicated by the bitmap.

In a specific implementation, the third information includes a bitmap having a length of N bits, and each of the N bits corresponds to a respective one of N multicast services. The terminal device may traverse each of the N bits and determine whether the multicast service corresponding to the bit is the multicast service to which the MAC layer control information is applicable based on a value of the bit. Specifically, when the value of the bit is a preset valid value, the multicast service corresponding to the bit is determined as the multicast service to which the MAC layer control information is applicable.

In another implementation, each of the N bits corresponds to a respective one of N indexes, the indexes are the indexes of the RNTIs, and the RNTIs have a correspondence with the multicast services. The terminal device traverses each of the N bits, when a value of the bit is a valid value, a first index corresponding to the bit is determined, a first RNTI is determined based on the first index, and a multicast service corresponding to the first RNTI is determined as the multicast service to which the MAC layer control information is applicable.

In another implementation, each of the N bits corresponds to a respective one of N RNTIs. The terminal device traverses each of the N bits, when a value of the bit is a valid value, a first RNTI corresponding to the bit is determined, and a multicast service corresponding to the first RNTI is determined as the multicast service to which the MAC layer control information is applicable.

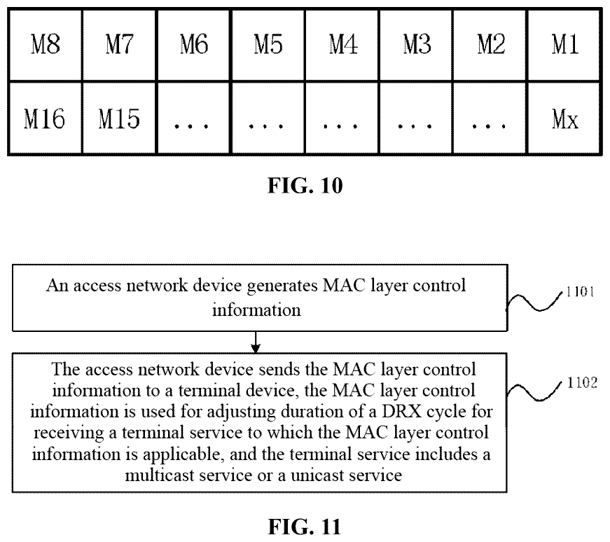

In an example, the third information includes the bitmap illustrated in FIG. 10. The bitmap includes N bits, which are M1 to Mx respectively. M1 indicates a multicast service 1, M2 indicates a multicast service 2 . . . and Mx indicates a multicast service x. The terminal device may determine x multicast services to which the MAC layer control information is applicable based on N bits in the MAC layer control information, and the terminal device may adjust the duration of the DRX cycle for receiving x multicast services based on the MAC layer control information.

It should be noted that N bits satisfy any one of the following mapping relationships: the N bits correspond sequentially, from a high bit to a low bit, to N multicast services; the N bits correspond sequentially, from a low bit to a high bit, to N multicast services; the N bits correspond sequentially, from a high bit to a low bit, to N RNTIs arranged in a descending order; the N bits correspond sequentially, from a low bit to a high bit, to N RNTIs arranged in an ascending order; the N bits correspond sequentially, from a high bit to a low bit, to N indexes arranged in a descending order; or the N bits correspond sequentially, from a low bit to a high bit, to N indexes arranged in an ascending order.

The embodiment of the disclosure does not limit the mapping relationship between N bits and the multicast services, the mapping relationship between N bits and the indexes, and the mapping relationship between N bits and the RNTIs. Any solution that indicates the multicast services to which the MAC layer control information is specifically applicable through N bits belongs to the scope of protection of the embodiments of the disclosure.

In a possible implementation, the RNTI involved in the above three implementations is a RNTI dedicated to the multicast service, that is, the G-RNTI described above.

In above three implementations of the third information, the third implementation has the lowest field overhead, and may realize the indication of specific multicast service through the less number of bits.

An embodiment of the disclosure further provides a method for adjusting duration of a DRX cycle, which is applicable to an access network device. As illustrated in FIG. 11, the method includes the following operations.

At operation 1101, an access network device generates MAC layer control information.

The MAC layer control information may be DRX-related MAC layer control information, for example, may be a DRX command MAC CE or a long DRX command MAC CE.

The access network device may generate a PDU at a MAC layer, which includes a subheader and a payload. The subheader contains a logical channel identification, the payload contains the MAC layer control information, and the logical channel identification in the subheader may indicate a type of the MAC layer control information in the payload. For example, the logical channel identification may indicate whether the payload contains the DRX command MAC CE or the long DRX command MAC CE. The logical channel identification may be a logical channel identity document, or LCID for short.

At operation 1102, the access network device sends the MAC layer control information to a terminal device. The MAC layer control information is used for adjusting the duration of the DRX cycle for receiving a terminal service to which the MAC layer control information is applicable. The terminal service includes a multicast service or a unicast service.

In a specific implementation, the access network device sends a MAC sub PDU, and the MAC sub PDU includes the MAC layer control information. The MAC layer control information instructs the terminal device to distinguish a service type when adjusting the duration of the DRX cycle, instead of blindly adjusting the duration of the DRX cycle. An adjustment of the duration of the DRX cycle is configured separately for the multicast service and the unicast service.

The multicast service may include multicast and broadcast, and the unicast service may be a point-to-point communication service between the terminal device and the access network device.

In a specific implementation, whether the MAC layer control information is applicable to the multicast service or the unicast service is indicated through content carried in the MAC layer control information; or whether the MAC layer control information is applicable to the multicast service or the unicast service is indicated through content carried in a subheader corresponding to the MAC layer control information; or whether the MAC layer control information is applicable to the multicast service or the unicast service is indicated through a receiving resource for the subheader. The subheader corresponding to the MAC layer control information is a subheader corresponding to the payload that carries the MAC layer control information.

In a possible implementation, the contents carried in the MAC layer control information may be a specified field in the MAC layer control information, for example, a reserved field, a reuse of an existing field, etc. The contents carried in the subheader may be a specified field in the subheader, for example, a reserved field, a reuse of an existing field, etc. The receiving resource for the subheader may be a PDSCH that carries the subheader, or may be a scrambling identifier of the PDSCH. The scrambling identifier may be a RNTI.

It should be noted that the MAC layer control information may be the DRX command MAC CE or the long DRX command MAC CE. When the MAC layer control information is the DRX command MAC CE, it instructs the terminal device to switch a DRX cycle of a terminal service, to which the DRX command MAC CE is applicable, to a DRX cycle indicated by the DRX command MAC CE. When the MAC layer control information is the long DRX command MAC CE, it instructs the terminal device to switch a DRX cycle of a terminal service, to which the long DRX command MAC CE is applicable, to a DRX cycle indicated by the long DRX command MAC CE.

In the method provided by the embodiment of the disclosure, the access network device can instruct, through the MAC layer control information, the terminal device to adjust the duration of the DRX cycle for the terminal service to which the MAC layer control information is applicable after receiving the MAC layer control information. Therefore, the duration of the DRX cycle may be switched differently for the reception of the multicast service and the reception of the unicast service, and the multicast service and the unicast service may be configured separately, which may prevent the terminal device from blindly switching the duration of the DRX cycle, and ensure that the switching of the duration of the DRX cycle matches with the service type accurately.

In another embodiment of the disclosure, the subheader corresponding to the MAC layer control information includes a logical information identification indicating a type of the MAC layer control information. The type of the MAC layer control information includes: the DRX-related MAC CE, the DRX command MAC CE or the long DRX command MAC CE.

In another embodiment of the disclosure, the logical channel identification further indicates the terminal service to which the MAC layer control information is applicable. A logical channel identification corresponding to the unicast service is different from a logical channel identification corresponding to the multicast service. That is, in order to distinguish between the unicast service and the multicast service, different logical channel identifications are defined for the MAC layer control information corresponding to the unicast service and the MAC layer control information corresponding to the multicast service. The access network device may indicate whether the MAC layer control information in the payload is applicable to the unicast service or the multicast service through the logical channel identification in the subheader.

In another embodiment of the disclosure, the subheader corresponding to the MAC layer control information carries a field indicating a terminal service, and the terminal device may determine whether the MAC layer control information is applicable to the multicast service or the unicast service based on the subheader. Illustratively, the subheader corresponding to the MAC layer control information includes first information. The first information indicates that the MAC layer control information is applicable to the unicast service or indicates that the MAC layer control information is applicable to the multicast service.

In another embodiment of the disclosure, the terminal service may be indicated through a RNTI for scheduling the MAC layer control information. Illustratively, the MAC layer control information is carried in a downlink data channel, and a RNTI of the downlink data channel indicates the terminal service to which the MAC layer control information is applicable.

In a specific implementation, the RNTI of the downlink data channel is a RNTI dedicated to the multicast service or a RNTI dedicated to the unicast service. The RNTI dedicated to the multicast service indicates that the MAC layer control information is applicable to the multicast service, and the RNTI dedicated to the unicast service indicates that the MAC layer control information is applicable to the unicast service.

That is, the MAC layer control information is applicable to the multicast service when the RNTI for scheduling the MAC layer control information is the RNTI dedicated to the multicast service. The MAC layer control information is applicable to the unicast service when the RNTI for scheduling the MAC layer control information is the RNTI dedicated to the unicast service.

For example, the access network device schedules a PDSCH by a PDCCH, scrambles the PDCCH with an RNTI, and the PDSCH carries a MAC sub PDU. The MAC sub PDU includes a subheader and MAC CE. When the MAC CE is applicable to the unicast service, C-RNTI is used to scramble the PDCCH. When the MAC CE is applicable to the multicast service, G-RNTI is used to scramble the PDCCH. The C-RNTI is an RNTI dedicated to scheduling the unicast service, and the G-RNTI is an RNTI dedicated to scheduling the multicast service.

In another embodiment of the disclosure, the subheader may contain a field indicating a length of the MAC layer control information in the payload, and the terminal service may be indicated by including or not including the field in the subheader. Illustratively, when the subheader corresponding to the MAC layer control information includes second information, it is indicated that the MAC layer control information is applicable to the multicast service; and when the subheader corresponding to the MAC layer control information does not include the second information, it is indicated that the MAC layer control information is applicable to the unicast service. The second information indicates a length of the MAC layer control information.

In another embodiment of the disclosure, when the subheader corresponding to the MAC layer control information includes the second information, the MAC layer control information further includes third information indicating an adjustment of duration of a DRX cycle for receiving one or more multicast services.

In a possible implementation, the third information includes one or more RNTIs, and the MAC layer control information is applicable to one or more multicast services corresponding to the one or more RNTIs.

In another possible implementation, the third information includes one or more indexes, the MAC layer control information is applicable to one or more multicast services corresponding to the one or more indexes, or the MAC layer control information is applicable to one or more multicast services corresponding to one or more RNTIs associated with the one or more indexes.

It should be noted that each of the one or more indexes corresponds a respective one of the one or more multicast services; or each of the one or more RNTIs associated with the one or more indexes corresponds to a respective one of the one or more multicast services.

In the embodiment of the disclosure, the third information has a length of N bits, and a value of each of the N bits indicates whether a multicast service corresponding to the bit is a multicast service to which the MAC layer control information is applicable.

It should be noted that N bits satisfy any one of the following mapping relationships: the N bits correspond sequentially, from a high bit to a low bit, to N multicast services; the N bits correspond sequentially, from a low bit to a high bit, to N multicast services; the N bits correspond sequentially, from a high bit to a low bit, to N RNTIs arranged in a descending order; the N bits correspond sequentially, from a low bit to a high bit, to N RNTIs arranged in an ascending order; the N bits correspond sequentially, from a high bit to a low bit, to N indexes arranged in a descending order; or the N bits correspond sequentially, from a low bit to a high bit, to N indexes arranged in an ascending order.

Optionally, the RNTI involved in the various implementations of the third information is an RNTI dedicated to the multicast service, that is, G-RNTI described above.

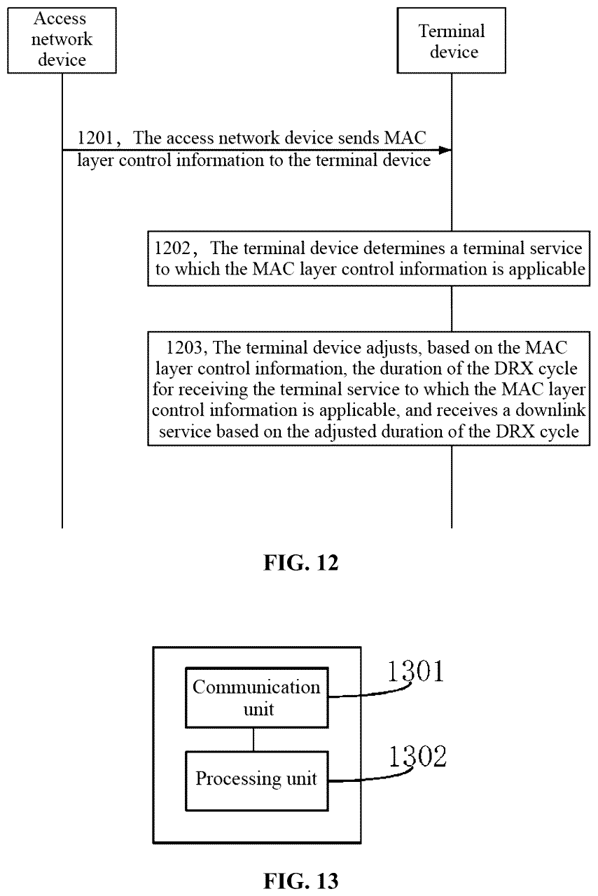

An embodiment of the disclosure further provides a method for adjusting duration of a DRX cycle, which is applicable to the terminal device and the access network device in the system illustrated in FIG. 2. As illustrated in FIG. 12, the method includes the following operations.

At operation 1201, the access network device sends MAC layer control information to the terminal device.

At operation 1202, the terminal device determines a terminal service to which the MAC layer control information is applicable.

Specifically, the terminal service to which the MAC layer control information is applicable is determined based on a field in the MAC layer control information; or the terminal service to which the MAC layer control information is applicable is determined based on a field in a subheader corresponding to the MAC layer control information; or a terminal service to which the MAC layer control information is applicable is determined based on an RNTI for scheduling the MAC layer control information.

At operation 1203, the terminal device adjusts, based on the MAC layer control information, the duration of the DRX cycle for receiving the terminal service to which the MAC layer control information is applicable, and receives a downlink service based on the adjusted duration of the DRX cycle.

The detailed implementation of each operation in the method illustrated in FIG. 12 is referred to the above description, which will not be repeated herein.

It should be understood that although various operations in the flowchart in the above embodiments are displayed sequentially as indicated by arrows, these operations are not necessarily performed in the order indicated by the arrows. Unless explicitly stated in the disclosure, there is no strict sequential limitation on the execution of these operations, and these operations may be performed in other orders. Furthermore, at least part of the operations in the respective flowchart may include multiple sub-operations or stages, which may not necessarily be completely at the same time, but may be performed at different times. The order in which the sub-operations or stages are performed may not necessarily be sequential, but may be performed in turn or alternately with at least part of other operations or sub-operation or stages of the other operations.

An embodiment of the disclosure further provides a terminal device. As illustrated in FIG. 13, the terminal device includes a communication unit 1301 and a processing unit 1302.

The communication unit 1301 is configured to receive MAC layer control information from an access network device.

The processing unit 1302 is configured to determine a terminal service to which the MAC layer control information is applicable, and the terminal service includes a multicast service or a unicast service.

The processing unit 1302 is further configured to adjust duration of a DRX cycle for receiving the terminal service.

In an embodiment, the processing unit 1302 is specifically configured to: determine a logical channel identification based on a subheader corresponding to the MAC layer control information, the logical channel identification indicating a type of the MAC layer control information; and adjust the duration of the DRX cycle for receiving the terminal service based on the MAC layer control information when the logical channel identification is a DRX-related logical channel identification.

In an embodiment, the processing unit 1302 is specifically configured to switch a DRX cycle corresponding to the terminal service to a DRX cycle indicated by the MAC layer control information.

In an embodiment, the processing unit 1302 is specifically configured to determine the terminal service to which the MAC layer control information is applicable based on the logical channel identification.

In an embodiment, a logical channel identification corresponding to the unicast service is different from a logical channel identification corresponding to the multicast service.

In an embodiment, the processing unit 1302 is specifically configured to: determine first information based on a subheader corresponding to the MAC layer control information, the first information indicating that the MAC layer control information is applicable to the unicast service or that the MAC layer control information is applicable to the multicast service; and determine the terminal service to which the MAC layer control information is applicable based on the first information.

In an embodiment, the first information is contained in the subheader corresponding to the MAC layer control information.

In an embodiment, the processing unit 1302 is specifically configured to determine a RNTI for scheduling the MAC layer control information; and determine the terminal service to which the MAC layer control information is applicable based on the RNTI.

In an embodiment, the MAC layer control information is applicable to the multicast service when the RNTI is an RNTI dedicated to the multicast service; and the MAC layer control information is applicable to the unicast service when the RNTI is an RNTI dedicated to the unicast service.

In an embodiment, the processing unit 1302 is specifically configured to determine whether a subheader corresponding to the MAC layer control information includes second information indicating a length of the MAC layer control information; and determine the terminal service to which the MAC layer control information is applicable based on the determination of whether the subheader corresponding to the MAC layer control information includes the second information.

In an embodiment, the processing unit 1302 is specifically configured to: determine that the MAC layer control information is applicable to the multicast service when the subheader corresponding to the MAC layer control information includes the second information; and determine that the MAC layer control information is applicable to the unicast service when the subheader corresponding to the MAC layer control information does not include the second information.

In an embodiment, when the subheader corresponding to the MAC layer control information includes the second information, the MAC layer control information includes third information indicating an adjustment of duration of a DRX cycle for receiving one or more multicast services.

In an embodiment, the processing unit 1302 is specifically configured to determine the one or more multicast services indicated by the third information as the terminal services to which the MAC layer control information is applicable.

In an embodiment, the processing unit 1302 is specifically configured to determine the one or more multicast services based on one or more RNTIs in the third information; and determine the one or more multicast services as the terminal services to which the MAC layer control information is applicable.

In an embodiment, the processing unit 1302 is specifically configured to determine the one or more multicast services to which the MAC layer control information is applicable based on one or more indexes in the third information.

In an embodiment, each of the one or more indexes corresponds to a respective one of the one or more multicast services; or each of one or more RNTIs corresponding to the one or more indexes corresponds to a respective one of the one or more multicast services.

In an embodiment, the third information has a length of N bits, and the processing unit 1302, when determining the one or more multicast services indicated by the third information as the terminal services to which the MAC layer control information is applicable, is specifically configured to: for each of the N bits, when a value of the bit is a preset valid value, determine a multicast service corresponding to the bit as the multicast service to which the MAC layer control information is applicable.

In an embodiment, the processing unit 1302 is specifically configured to: determine a first RNTI corresponding to the bit, and determine a multicast service corresponding to the first RNTI as the multicast service to which the MAC layer control information is applicable; or, determine a first index corresponding to the bit, determine a first RNTI based on the first index, and determine a multicast service corresponding to the first RNTI as the multicast service to which the MAC layer control information is applicable.

In an embodiment, the N bits satisfy one of the following mapping relationships: the N bits correspond sequentially, from a high bit to a low bit, to N multicast services; the N bits correspond sequentially, from a low bit to a high bit, to N multicast services; the N bits correspond sequentially, from a high bit to a low bit, to N RNTIs arranged in a descending order; the N bits correspond sequentially, from a low bit to a high bit, to N RNTIs arranged in an ascending order; the N bits correspond sequentially, from a high bit to a low bit, to N indexes arranged in a descending order; or the N bits correspond sequentially, from a low bit to a high bit, to N indexes arranged in an ascending order.

In an embodiment, the one or more RNTIs are RNTIs dedicated to the multicast service.

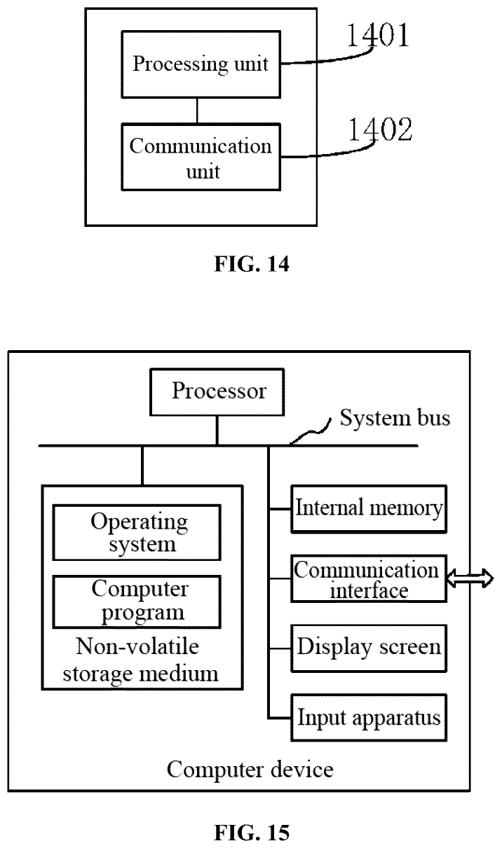

An embodiment of the disclosure further provides an access network device, as illustrated in FIG. 14, which includes a processing unit 1401 and a communication unit 1402.

The processing unit 1401 is configured to generate MAC layer control information.

The communication unit 1402 is configured to send the MAC layer control information to a terminal device. The MAC layer control information is used for adjusting duration of a DRX cycle for receiving a terminal service to which the MAC layer control information is applicable. The terminal service includes a multicast service or a unicast service.

In an embodiment, a subheader corresponding to the MAC layer control information includes a logical channel identification indicating a type of the MAC layer control information. For example, the logical channel identification may indicate the MAC layer control information to be a DRX command MAC CE, so that the terminal device may adjust the duration of the DRX cycle.

In an embodiment, the operation of adjusting the duration of the DRX cycle includes: switching a DRX cycle corresponding to the terminal service to a DRX cycle indicated by the MAC layer control information.

In an embodiment, the logical channel identification further indicates the terminal service to which the MAC layer control information is applicable.

In an embodiment, a logical channel identification corresponding to the unicast service is different from a logical channel identification corresponding to the multicast service.

In an embodiment, a subheader corresponding to the MAC layer control information includes first information indicating that the MAC layer control information is applicable to the unicast service or that the MAC layer control information is applicable to the multicast service.

In an embodiment, the MAC layer control information is carried in a downlink data channel, and a RNTI of the downlink data channel indicates the terminal service to which the MAC layer control information is applicable.

In an embodiment, the RNTI of the downlink data channel is a RNTI dedicated to the multicast service or a RNTI dedicated to the unicast service.

The RNTI dedicated to the multicast service indicates that the MAC layer control information is applicable to the multicast service, and the RNTI dedicated to the unicast service indicates that the MAC layer control information is applicable to the unicast service.

In an embodiment, when a subheader corresponding to the MAC layer control information includes second information, it indicates that the MAC layer control information is applicable to the multicast service. When the subheader corresponding to the MAC layer control information does not include the second information, it indicates that the MAC layer control information is applicable to the unicast service. The second information indicates a length of the MAC layer control information.

In an embodiment, when the subheader corresponding to the MAC layer control information includes the second information, the MAC layer control information further includes third information indicating an adjustment of duration of a DRX cycle for receiving one or more multicast services.

In an embodiment, the third information includes one or more RNTIs, and the MAC layer control information is applicable to one or more multicast services corresponding to the one or more RNTIs.

In an embodiment, the third information includes one or more indexes, the MAC layer control information is applicable to one or more multicast services corresponding to the one or more indexes, or the MAC layer control information is applicable to one or more multicast services corresponding to one or more RNTIs associated with the one or more indexes.

In an embodiment, each of the one or more indexes corresponds to a respective one of the one or more multicast services, or each of one or more RNTIs associated with the one or more indexes corresponds to a respective one of the one or more multicast services.

In an embodiment, the third information has a length of N bits, and a value of each of the N bits indicates whether a multicast service corresponding to the bit is a multicast service to which the MAC layer control information is applicable.

In an embodiment, the N bits satisfy one of the following mapping relationships: the N bits correspond sequentially, from a high bit to a low bit, to N multicast services; the N bits correspond sequentially, from a low bit to a high bit, to N multicast services; the N bits correspond sequentially, from a high bit to a low bit, to N RNTIs arranged in a descending order; the N bits correspond sequentially, from a low bit to a high bit, to N RNTIs arranged in an ascending order; the N bits correspond sequentially, from a high bit to a low bit, to N indexes arranged in a descending order; or the N bits correspond sequentially, from a low bit to a high bit, to N indexes arranged in an ascending order.

In an embodiment, the one or more RNTIs are RNTIs dedicated to the multicast service.

In an embodiment, a computer device is provided, which may be a terminal device. The internal structural diagram of the computer device may be illustrated in FIG. 15. The computer device includes a processor, a memory, a communication interface, a display screen, and an input apparatus connected through a system bus. The processor of the computer device is configured to provide computing and control capabilities. The memory of the computer device includes a non-volatile storage medium and an internal memory. The non-volatile storage medium stores an operating system and a computer program. The internal memory provides an environment for the operation of the operating system and the computer program in the non-volatile storage medium. The communication interface of the computer device is configured to communicate with an external terminal in a wired or wireless manner. The wireless manner may be implemented through WIFI, an operator network, NFC (Near Field Communication) or other technologies. The computer program is executed by the processor to perform a method for adjusting duration of a DRX cycle according to an embodiment of the disclosure. The display screen of the computer device may be a liquid crystal display screen or an electronic ink display screen. The input apparatus of the computer device may be a touch layer covered on the display screen; or may be a button, a trackball or a touchpad set on a shell of the computer device; or may be an external keyboard, a touchpad or a mouse, etc. Illustratively, the computer device illustrated in FIG. 15 may perform the method for adjusting the duration of the DRX cycle described above.

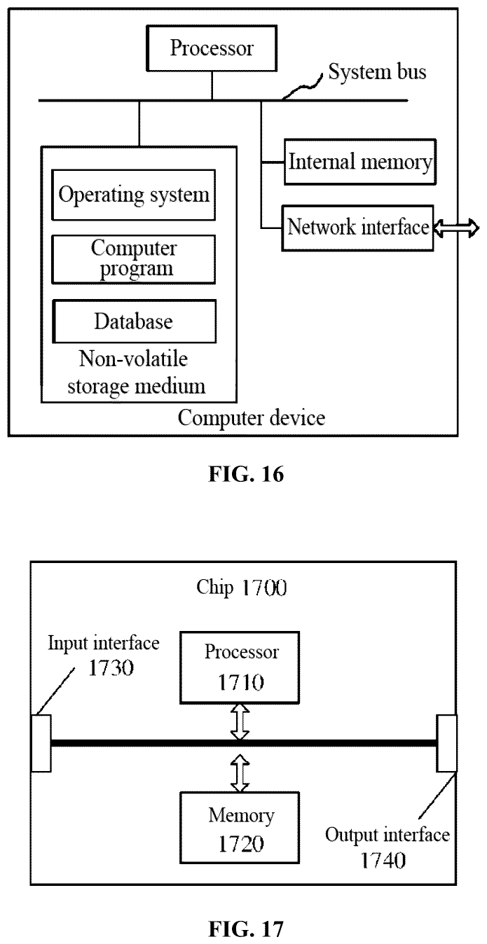

In an embodiment, a computer device is provided, which may be an access network device as described above. The internal structural diagram of the computer device may be illustrated in FIG. 16. The computer device includes a processor, a memory and a network interface connected through a system bus. The processor of the computer device is configured to provide computing and control capabilities. The memory of the computer device includes a non-volatile storage medium and an internal memory. The non-volatile storage medium stores an operating system, a computer program and a database. The internal memory provides an environment for the operation of the operating system and the computer program in the non-volatile storage medium. The database of the computer device may store configuration information, authority information, etc. The network interface of the computer device is configured to communicate with an external terminal through a network connection. The computer program is executed by the processor to implement the method for adjusting the duration of the DRX cycle described in the above embodiments of the disclosure.

In an embodiment, a computer-readable storage medium is provided. The computer-readable storage medium has stored thereon a computer program that, when executed by a processor, causes a terminal to perform the method for adjusting the duration of the DRX cycle described in the above embodiments of the disclosure.

In an embodiment, a computer-readable storage medium is provided. The computer-readable storage medium has stored thereon a computer program that, when executed by a processor, causes an access network device to perform the method for adjusting the duration of the DRX cycle described in the above embodiments of the disclosure.

In the methods and apparatuses for adjusting the duration of the DRX cycle, the devices and the storage medium provided by the embodiments of the disclosure, after receiving the MAC layer control information from the access network device, the terminal device may determine whether the MAC layer control information is applicable to the multicast service or the unicast service, so that the duration of the DRX cycle may be switched differentially for the reception of the multicast service or the reception of the unicast service, and the multicast service and the unicast service may be configured separately, which may prevent the terminal device from blindly switching the duration of the DRX cycle, and ensure that the switching of the duration of the DRX cycle matches with the service type accurately.

Those skilled in the art will understood that the configuration illustrated in FIG. 15 or FIG. 16 is only a block diagram of a portion of the structure related to the solution of the disclosure and does not constitute a limitation on the network device or terminal to which the solution of the disclosure is applied. The specific network device or terminal may include more or fewer components than that illustrated in the figure, or may combine certain components, or may have a different component arrangement.

Each module in the terminal device and the access network device provided in the embodiments of the disclosure may be implemented in the form of a computer program. The computer program may be run on a terminal or a server. The program module composed of the computer program may be stored on a memory of the terminal or a memory of the server. The computer program, when executed by a processor, causes the processor to perform the operations of the methods described in the embodiments of the disclosure.

FIG. 17 is a structural diagram of a chip according to an embodiment of the disclosure. The chip 1700 illustrated in FIG. 17 includes a processor 1710, and the processor 1710 may call a computer program from a memory and run the computer program to perform the method in the embodiments of the disclosure.

Optionally, as illustrated in FIG. 17, the chip 1700 may further include a memory 1720. The processor 1710 may call the computer program from the memory 1720 and run the computer program to perform the method in the embodiments of the disclosure.

The memory 1720 may be a separate device independent of the processor 1710, and may also be integrated into the processor 1710.

Optionally, the chip 1700 may further include an input interface 1730. The processor 1710 may control the input interface 1730 to communicate with other devices or chips. Specifically, the input interface may be controlled to acquire information or data sent by other devices or chips.

Optionally, the chip 1700 may further include an output interface 1740. The processor 1710 may control the output interface 1740 to communicate with other devices or chips. Specifically, the output interface may be controlled to output information or data to other devices or chips.

Optionally, the chip may be applied to the access network device in the embodiments of the disclosure, and the chip may implement corresponding flows implemented by the access network device in each method in the embodiments of the disclosure. For simplicity, elaborations are omitted herein.

Optionally, the chip may be applied to the terminal device in the embodiments of the disclosure, and the chip may implement corresponding flows implemented by the terminal device in each method in the embodiments of the disclosure. For simplicity, elaborations are omitted herein.

It is to be understood that the chip mentioned in the embodiments of the disclosure may also be called a system-level chip, a system chip, a chip system or a system on chip, etc.

It is to be understood that the processor in the embodiments of the disclosure may be an integrated circuit chip and has a signal processing capability. In an implementation process, each step in the method embodiments may be completed by an integrated logical circuit in a hardware form in the processor or an instruction in a software form. The processor may be a general purpose processor, a Digital Signal Processor (DSP), an Application Specific Integrated Circuit (ASIC), a Field Programmable Gate Array (FPGA) or another programmable logical device, discrete gate or transistor logical device and discrete hardware component. Each method, step and logical block diagram disclosed in the embodiments of the disclosure may be implemented or executed by the processor. The general purpose processor may be a microprocessor or the processor may also be any conventional processor and the like. The steps in the method disclosed in combination with the embodiments of the disclosure may be directly embodied to be executed and completed by a hardware decoding processor or executed and completed by a combination of hardware in the decoding processor and software modules. The software module may be located in a mature storage medium in this field such as a Random Access Memory (RAM), a flash memory, a Read-Only Memory (ROM), a Programmable ROM (PROM) or Electrically Erasable PROM (EEPROM) and a register. The storage medium is located in a memory, and the processor reads information in the memory, and completes the steps in the above methods in combination with the hardware of the processor.

It can be understood that the memory in the embodiment of the disclosure may be a volatile memory or a nonvolatile memory, or may include both the volatile and nonvolatile memories. The nonvolatile memory may be a ROM, a PROM, an Erasable PROM (EPROM), an EEPROM or a flash memory. The volatile memory may be a RAM, and is used as an external high-speed cache. In an exemplary and non-limiting example, RAMs in various forms may be adopted, such as a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM) and a Direct Rambus RAM (DR RAM). It is to be noted that the memory for the system and method described in the disclosure is intended to include, but not limited to, these and any other suitable types of memories.

It is to be understood that the description of the memory is exemplary and non-limiting. For example, the memory in the embodiments of the disclosure may also be an SRAM, a DRAM, an SDRAM, a DDR SDRAM, an ESDRAM, an SLDRAM, a DR RAM and the like.

That is, the memory in the embodiments of the disclosure is intended to include, but not limited to, these and any other suitable types of memories.

The embodiments of the disclosure further provide a computer program product, which includes computer program instructions.

Optionally, the computer program product may be applied to the access network device in the embodiments of the disclosure, and the computer program instructions enable a computer to execute corresponding flows implemented by the access network device in each method in the embodiments of the disclosure. For simplicity, elaborations are omitted herein.

Optionally, the computer program product may be applied to the terminal device in the embodiments of the disclosure, and the computer program instructions enable a computer to execute corresponding flows implemented by the terminal device in each method in the embodiments of the disclosure. For simplicity, elaborations are omitted herein.

The embodiments of the disclosure further provide a computer program.

Optionally, the computer program may be applied to the access network device in the embodiments of the disclosure, and the computer program, when being executed in a computer, causes the computer to execute corresponding flows implemented by the access network device in each method in the embodiments of the disclosure. For simplicity, elaborations are omitted herein.

Optionally, the computer program may be applied to the terminal device in the embodiments of the disclosure, and the computer program, when being executed in a computer, causes the computer to execute corresponding flows implemented by the terminal device in each method in the embodiments of the disclosure. For simplicity, elaborations are omitted herein.

Those of ordinary skill in the art may realize that the units and algorithm steps of each example described in combination with the embodiments disclosed in the disclosure may be implemented by electronic hardware or a combination of computer software and the electronic hardware. Whether these functions are executed in a hardware or software manner depends on specific applications and design constraints of the technical solutions. Professionals may implement the described functions for each specific application by use of different methods, but such implementation shall fall within the scope of the disclosure.

Those skilled in the art may clearly learn about that specific working processes of the system, device and unit described above may refer to the corresponding processes in the method embodiment and will not be elaborated herein for convenient and brief description.

In some embodiments provided by the disclosure, it is to be understood that the disclosed system, device and method may be implemented in another manner. For example, the device embodiment described above is only schematic, and for example, division of the units is only logic function division, and other division manners may be adopted during practical implementation. For example, multiple units or components may be combined or integrated into another system, or some characteristics may be neglected or not executed. In addition, coupling or direct coupling or communication connection between displayed or discussed components may be indirect coupling or communication connection through some interfaces, devices or units, and may be electrical, mechanical or in other forms.

The units described as separate parts may or may not be physically separated, and parts displayed as units may or may not be physical units, and namely may be located in the same place, or may also be distributed onto multiple network units. Part or all of the units may be selected to achieve the purpose of the solutions in the embodiments according to a practical requirement.

In addition, each functional unit in each embodiment of the disclosure may be integrated into a processing unit, each unit may also exist physically and independently, and two or more than two units may also be integrated into a unit.

When being realized in form of software functional unit and sold or used as an independent product, the function may also be stored in a computer-readable storage medium. Based on such an understanding, the technical solutions of the disclosure substantially or parts making contributions to the conventional art or part of the technical solutions may be embodied in form of software product, and the computer software product is stored in a storage medium, including a plurality of instructions configured to enable a computer device (which may be a personal computer, a server, a network device or the like) to execute all or part of the steps of the method in each embodiment of the disclosure. The abovementioned storage medium includes: various media capable of storing program codes such as a U disk, a mobile hard disk, a ROM, a RAM, a magnetic disk or an optical disk.

Described above are merely specific embodiments of the disclosure and the scope of protection of the disclosure is not limited thereto. Any variation or replacement easily conceivable by those skilled in the art within the technical scope disclosed by the disclosure shall fall within the scope of protection of the disclosure. Therefore, the scope of protection of the disclosure shall be subject to the scope of protection of the claims.

1. A method for adjusting duration of a Discontinuous Reception (DRX) cycle, comprising:
receiving, by a terminal device, Media Access Control (MAC) layer control information from an access network device;
determining, by the terminal device, a terminal service to which the MAC layer control information is applicable, wherein the terminal service comprises a multicast service or a unicast service; and
adjusting, by the terminal device, the duration of the DRX cycle for receiving the terminal service.

2. The method of claim 1, wherein adjusting, by the terminal device, the duration of the DRX cycle for receiving the terminal service comprises:
determining a logical channel identification based on a subheader corresponding to the MAC layer control information, the logical channel identification indicating a type of the MAC layer control information; and
adjusting the duration of the DRX cycle for receiving the terminal service based on the MAC layer control information when the logical channel identification is a DRX-related logical channel identification.

3. The method of claim 1, wherein determining, by the terminal device, the terminal service to which the MAC layer control information is applicable comprises:
determining first information based on a subheader corresponding to the MAC layer control information, the first information indicating that the MAC layer control information is applicable to the unicast service or that the MAC layer control information is applicable to the multicast service; and
determining the terminal service to which the MAC layer control information is applicable based on the first information.

4. The method of claim 1, wherein determining, by the terminal device, the terminal service to which the MAC layer control information is applicable comprises:
determining a Radio Network Temporary Identifier (RNTI) for scheduling the MAC layer control information; and
determining the terminal service to which the MAC layer control information is applicable based on the RNTI.

5. The method of claim 4, wherein determining the terminal service to which the MAC layer control information is applicable based on the RNTI comprises:
determining that the MAC layer control information is applicable to the multicast service when the RNTI is an RNTI dedicated to the multicast service; and
determining that the MAC layer control information is applicable to the unicast service when the RNTI is an RNTI dedicated to the unicast service.

6. A terminal device, comprising:
a processor, a memory and a transceiver, wherein the processor, the memory and the transceiver communicate with each other via an internal connection path, wherein
the memory is configured to store program codes; and
the processor is configured to call the program codes stored in the memory to:
control the transceiver to receive Media Access Control (MAC) layer control information from an access network device;
determine a terminal service to which the MAC layer control information is applicable, the terminal service comprising a multicast service or a unicast service; and
adjust duration of a Discontinuous Reception (DRX) cycle for receiving the terminal service.

7. The terminal device of claim 6, wherein the processor is further configured to:
determine a Radio Network Temporary Identifier (RNTI) for scheduling the MAC layer control information; and
determine the terminal service to which the MAC layer control information is applicable based on the RNTI.

8. The terminal device of claim 7, wherein the processor is further configured to:
determine that the MAC layer control information is applicable to the multicast service when the RNTI is an RNTI dedicated to the multicast service; and
determine that the MAC layer control information is applicable to the unicast service when the RNTI is an RNTI dedicated to the unicast service.

9. The terminal device of claim 6, wherein the processor is further configured to:
determine whether a subheader corresponding to the MAC layer control information comprises second information indicating a length of the MAC layer control information; and
determine the terminal service to which the MAC layer control information is applicable based on the determination of whether the subheader corresponding to the MAC layer control information comprises the second information.

10. The terminal device of claim 9, wherein
when the subheader corresponding to the MAC layer control information comprises the second information, the MAC layer control information comprises third information indicating an adjustment of duration of a DRX cycle for receiving one or more multicast services.

11. The terminal device of claim 10, wherein the processor is further configured to:
determine the one or more multicast services indicated by the third information as the terminal services to which the MAC layer control information is applicable.

12. The terminal device of claim 11, wherein the processor is further configured to:
determine the one or more multicast services based on one or more Radio Network Temporary Identifiers (RNTIs) in the third information; and determine the one or more multicast services as the terminal services to which the MAC layer control information is applicable;
or
determine the one or more multicast services to which the MAC layer control information is applicable based on one or more indexes in the third information;
or
the third information has a length of N bits, for each of the N bits, when a value of the bit is a preset valid value, determine a multicast service corresponding to the bit as the multicast service to which the MAC layer control information is applicable.

13. An access network device, comprising:
a processor, a memory and a transceiver, wherein the processor, the memory and the transceiver communicate with each other via an internal connection path, wherein
the memory is configured to store program codes; and
the processor is configured to call the program codes stored in the memory to:
generate Media Access Control (MAC) layer control information; and
control the transceiver to send the MAC layer control information to a terminal device, the MAC layer control information being used for adjusting duration of a Discontinuous Reception (DRX) cycle for receiving a terminal service to which the MAC layer control information is applicable, wherein the terminal service comprises a multicast service or a unicast service.

14. The access network device of claim 13, wherein a subheader corresponding to the MAC layer control information comprises a logical channel identification indicating a type of the MAC layer control information.

15. The access network device of claim 13, wherein a subheader corresponding to the MAC layer control information comprises first information indicating that the MAC layer control information is applicable to the unicast service or that the MAC layer control information is applicable to the multicast service.

16. The access network device of claim 13, wherein the MAC layer control information is carried in a downlink data channel, and a Radio Network Temporary Identifier (RNTI) of the downlink data channel indicates the terminal service to which the MAC layer control information is applicable.

17. The access network device of claim 16, wherein the RNTI of the downlink data channel is an RNTI dedicated to the multicast service or an RNTI dedicated to the unicast service, wherein
the RNTI dedicated to the multicast service indicates that the MAC layer control information is applicable to the multicast service, and the RNTI dedicated to the unicast service indicates that the MAC layer control information is applicable to the unicast service.

18. The access network device of claim 13, wherein
when a subheader corresponding to the MAC layer control information comprises second information, it indicates that the MAC layer control information is applicable to the multicast service; and
when the subheader corresponding to the MAC layer control information does not comprise the second information, it indicates that the MAC layer control information is applicable to the unicast service;
wherein the second information indicates a length of the MAC layer control information.

19. The access network device of claim 18, wherein when the subheader corresponding to the MAC layer control information comprises the second information, the MAC layer control information further comprises third information indicating an adjustment of duration of a DRX cycle for receiving one or more multicast services.

20. A chip, comprising: a processor configured to call a computer program from a memory and run the computer program, to enable a device equipped with the chip to perform operations of the method of claim 1.
